(19) United States
(12) Patent Application Publication
(10) Pub. No.: US 2002/0186235 A1
(43) Pub. Date: Dec. 12, 2002

(54) Compact visual summaries using superhistograms and frame signatures

(75) Inventors: Nevenka Dimitrova, Yorktown Heights, NY (US); Lalitha Agnihotri, Fishkill, NY (US); Thomas Francis McGee III, Garrison, NY (US)

Correspondence Address: Corporate Patent Counsel;, U. S. Philips Corporation, 580 White Plains Road, Tarrytown, NY, 10591, US

(73) Assignee: KONINKLIJKE PHILIPS ELECTRONICS N.V.

(21) Appl. No.: 09/866,394

(22) Filed: May 25, 2001

(51) Int. Cl. G09G 5/00

(52) U.S. Cl. 345/723

(57) ABSTRACT

For use in a system capable of creating visual summaries of video material, there is disclosed an improved apparatus and method for creating a compact visual summary of video material. In one advantageous embodiment, the apparatus of the present invention comprises a visual summary controller that is capable of receiving keyframes of video material, and capable of extracting frame signatures from the keyframes, and capable of using the frame signatures to create superhistograms from the keyframes, and capable of using the frame signatures and the superhistograms to create a compact visual summary of the video material. The visual summary controller uses the superhistograms to filter and cluster the keyframes, and adds representative keyframes from the clustered keyframes to the compact visual summary. A visual summary retrieval module retrieves and displays a compact visual summary in response to a user request.

### RELATED APPLICATION

This patent application is related to co-pending U.S. patent application Ser. No. 09/116,769 filed Jul. 16, 1998 by Martino et al. entitled “A Histogram Method for Characterizing Video Content.” The disclosure in U.S. patent application Ser. No. 09/116,769 is hereby incorporated by reference in the present patent application as if fully set forth herein.

### TECHNICAL FIELD OF THE INVENTION

The present invention is directed, in general, to the creation of visual summaries of video material, more specifically, to a system and method that creates compact visual summaries using superhistograms and frame signatures.

### BACKGROUND OF THE INVENTION

A wide variety of video recorders are available in the marketplace. Most people own, or are familiar with, a video cassette recorder (VCR). A video cassette recorder records video programs on magnetic cassette tapes. More recently, video recorders have appeared in the market that use computer magnetic hard disks rather than magnetic cassette tapes to store video programs. For example, the ReplayTV™ recorder and the TiVO™ recorder digitally record television programs on hard disk drives using, for example, an MPEG video compression standard. Additionally, some video recorders may record on a readable/writable, digital versatile disk (DVD) rather than a magnetic disk.

The widespread use of video recorders has generated and continues to generate large volumes of video materials. The existence of large volumes of video materials has created a demand for systems that are capable of creating summaries of video materials. Summaries of video materials can be visual summaries, audio summaries, or textual summaries, or combinations of visual, audio and textual summaries. Presently existing methods for creating visual summaries generally involve extracting keyframes from the video material. An improved method for creating visual summaries involves extracting frame signatures from the keyframes and then using the frame signatures to filter the keyframes. However, these methods still leave a large number of keyframes remaining after the filtering process has been completed.

Many presently existing devices have limited storage capacity. For example, personal digital assistants (PDAs) and other similar types of devices are not able to store large amounts of data. Such devices cannot effectively use visual summaries that contain a large number of keyframes.

There is therefore a need for an improved system and method that is capable of creating a compact visual summary. There is a need for an improved system and method that is capable of selectively creating a compact visual summary that contains fewer keyframes than prior art visual summaries contain.

### SUMMARY OF THE INVENTION

It is an object of the present invention to provide an improved system and method for creating compact visual summaries.

It is also an object of the present invention to provide an improved system and method for creating compact visual summaries using superhistograms and frame signatures.

In one advantageous embodiment, the apparatus of the present invention comprises a visual summary controller that is capable of (1) receiving keyframes of video material, and (2) extracting frame signatures from the keyframes, and (3) using the frame signatures to create superhistograms from the keyframes, and (4) using the frame signatures and the superhistograms to create a compact visual summary of the video material. The visual summary controller uses the superhistograms to filter and cluster the keyframes, and adds representative frames from the clustered keyframes to the compact visual summary.

The visual summary controller also comprises a visual summary retrieval module that retrieves a visual summary from storage and displays the visual summary in response to a user request.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary system for creating visual summaries comprising an advantageous embodiment of the present invention;

FIG. 2 illustrates computer software that may be used with an advantageous embodiment of the present invention;

FIG. 3 illustrates an exemplary superhistogram comprising three family histograms; and

FIG. 4 illustrates a flow diagram showing an advantageous embodiment of a method of the present invention.

### DETAILED DESCRIPTION OF THE INVENTION

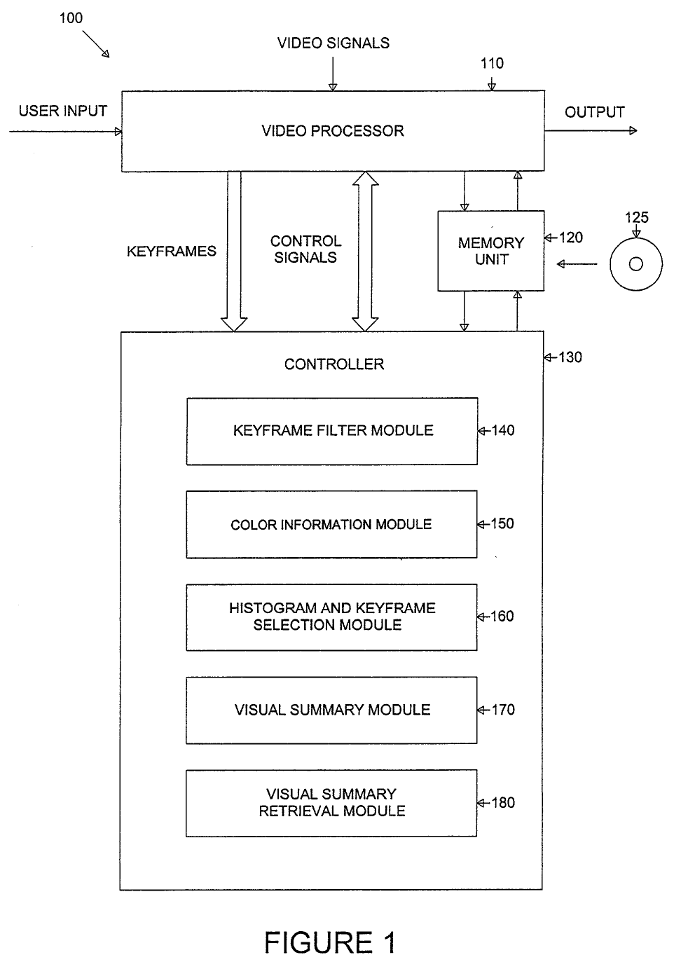

FIGS. 1 through 4, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, one particular type of system for creating visual summaries. Those skilled in the art will recognize that the exemplary embodiment of the present invention may easily be modified for use in other types of systems for creating visual summaries.

FIG. 1 illustrates a block diagram of an exemplary system 100 for creating visual summaries. System 100 comprises video processor 110. Video processor 110 receives video signals, formats the video signals into frames, and identifies keyframes. One example of this type of video processor is described in U.S. Pat. No. 6,137,544 by Dimitrova et al. issued on Oct. 24, 2000 entitled “Significant Scene Detection and Frame Filtering for a Visual Indexing System.” U.S. Pat. No. 6,137,544 and the disclosures therein are hereby incorporated by reference in the present patent application as if fully set forth herein.

Video processor 110 stores the keyframes in memory unit 120. Memory unit 120 may comprise random access memory (RAM). Memory unit 120 may comprise a non-volatile random access memory (RAM), such as flash memory. Memory unit 120 may comprise a mass storage data device, such as a hard disk drive (not shown). Memory unit 120 may also comprise an attached peripheral drive or removable disk drive (whether embedded or attached) that reads read/write DVDs or re-writable CD-ROMs. As illustrated in FIG. 1, removable disk drives of this type are capable of receiving and reading re-writable CD-ROM disk 125.

Video processor 110 provides the keyframes to controller 130 of the present invention. Controller 130 is capable of receiving control signals from video processor 110 and sending control signals to video processor 110. Controller 130 is also coupled to video processor 110 through memory unit 120. As will be more fully described, controller 130 is capable of creating a compact visual summary from the keyframes received from video processor 110. Controller 130 creates compact visual summaries that contain fewer keyframes than the number of keyframes in visual summaries created by prior art visual summary systems. Controller 130 stores each compact visual summary in memory unit 120. Video processor 110, in response to a user request, accesses the compact visual summary stored in memory unit 120 and outputs the compact visual summary to a display (not shown) that is viewed by the user.

As shown in FIG. 1, controller 130 comprises keyframe filter module 140, color information module 150, histogram and keyframe selection module 160, visual summary module 170, and visual summary retrieval module 180. As will be more fully described, keyframe filter module 140 extracts frame signatures from the keyframes, and then uses the frame signatures to filter the keyframes that controller 130 receives from video processor 110. Color information module 150 generates color information from the filtered keyframes. Histogram and keyframe selection module 160 derives superhistograms from the color information and selects representative keyframes from the superhistograms. Visual summary module 170 then creates a compact visual summary using the selected keyframe images. Visual summary module 170 then stores the compact visual summary in memory unit 120.

Visual summary retrieval module 180, in response to a user request received through video processor 110, accesses those visual summaries that match the user request. When a match is found, visual summary retrieval module 180 identifies the appropriate visual summary to video processor 110. Video 110 then outputs the visual summary to a display (not shown) for the user.

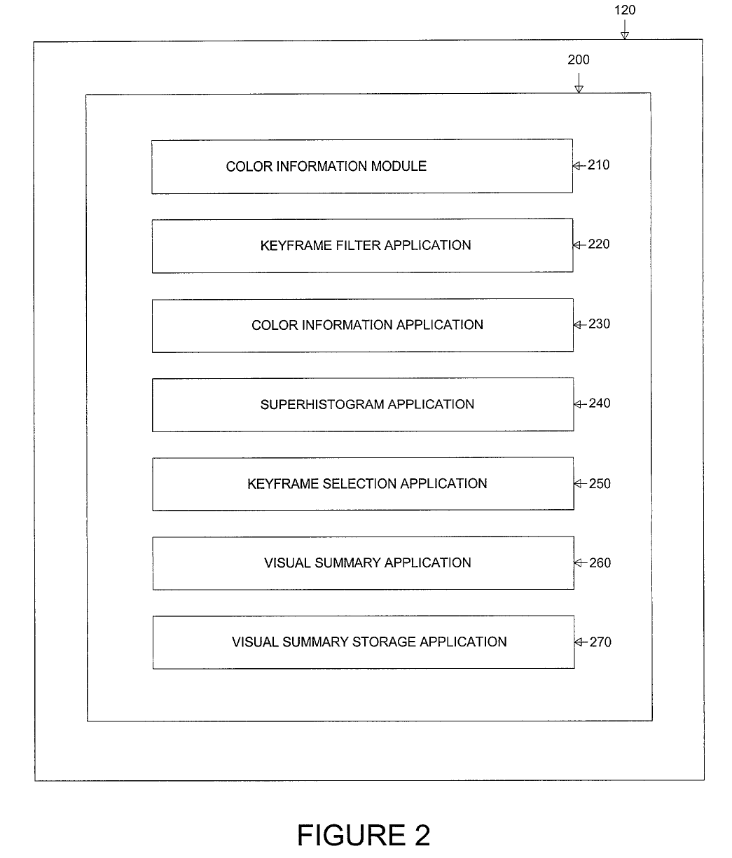

Controller 130 must identify the appropriate keyframes to be used to create a compact visual summary. An advantageous embodiment of the present invention comprises computer software 200 capable of identifying the appropriate keyframes to be used to create a compact visual summary for the video material. FIG. 2 illustrates a selected portion of memory unit 120 that contains computer software 200 of the present invention. Memory unit 120 contains operating system interface program 210, keyframe filter application 220, color information application 230, superhistogram application 240, keyframe selection application 250, visual summary application 260, and visual summary storage locations 270.

Controller 130 and computer software 200 together comprise a visual summary controller that is capable of carrying out the present invention. Under the direction of instructions in computer software 200 stored within memory unit 120, controller 130 creates a compact visual summary for the video material, stores the compact visual summary in visual summary storage locations 270, and replays the stored visual summary at the request of the user. Operating system interface program 210 coordinates the operation of computer software 200 with the operating system of controller 130.

To create a compact visual summary, the visual summary controller of the present invention (comprising controller 130 and software 200) first executes keyframe filter application 220 to extract frame signatures from the keyframes that controller 130 has received from video processor 110. Keyframe filter application 220 then uses the frame signatures to filter the keyframes. The filtering process reduces the number of keyframes.

Controller 130 then executes color information application 230 to derive color information from the filtered keyframes. Controller 130 then executes superhistogram application 240 to derive superhistograms from the color information. Superhistogram application 240 operates on the principles discussed in the article by N. Dimitrova et al. entitled “Color Super Histograms for Video Representation,” pp. 314-318, Volume 3, Proceedings of the IEEE International Conference on Image Processing, Japan, October 1999. This article is hereby incorporated herein by reference for all purposes. Superhistogram application 240 operates on principles discussed in co-pending U.S. patent application Ser. No. 09/116,769 filed Jul. 16, 1998 by Martino et al. entitled “A Histogram Method for Characterizing Video Content.” The disclosure in U.S. patent application Ser. No. 09/116,769 is hereby incorporated herein by reference for all purposes.

Superhistogram application 240 computes superhistograms by computing color histograms for individual shots and then merging the histograms into a single cumulative histogram called a family histogram based on a comparison measure. A family histogram originally represents the color union of two shots. As new frames are added, the family histogram accumulates the new colors from the respective shots. If a histogram of a new frame differs from the family histograms previously constructed, then a new family histogram is formed. An entire television program, for example, may be represented by a few family histograms. The set of family histograms is ordered with respect to the length of the temporal segment of video that they represent. The ordered set of family histograms is called a superhistogram.

As described in the article “Color Super Histograms for Video Representation,” histogram differences may be calculated by using any one of the following methods: (1) L1 distance measure, and (2) L2 distance measure, and (3) Histogram intersection, and (4) Chi Square test, and (5) Bin-wise histogram intersection. Superhistogram application 240 calculates a distance measure for clustering that is equal to the histogram difference between the keyframes weighted by the distance between the video cuts.

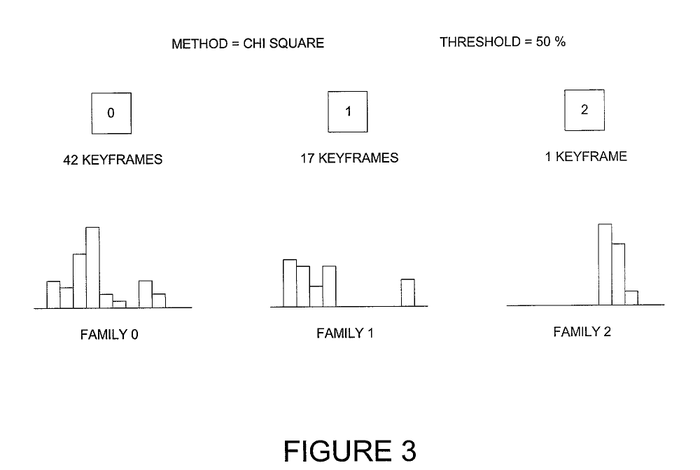

FIG. 3 illustrates an exemplary superhistogram comprising three family histograms. The superhistogram illustrated in FIG. 3 was obtained using a Chi Square distance measure and a threshold of fifty percent (50%). The three family histograms are denoted “Family 0”, “Family 1”, and “Family 2.” In this illustrative example Family 0 has forty two (42) keyframes, Family 1 has seventeen (17) keyframes, and Family 2 has one (1) keyframe. The three family histograms (together with associated information) make up the superhistogram.

Table I below contains an exemplary set of final results of the superhistogram extraction method using automatically extracted keyframes. The method is more fully described in the article “Color Super Histograms for Video Representation.” Table 1 shows the results of five histogram differencing methods (i.e., comparison methods) using various thresholds. As the results show, the total number of families derived for smaller thresholds ranges from one hundred eighty (180) to five hundred (500). As the threshold for similarity grows, however, a smaller number of families is obtained, but with longer duration (i.e., a larger number of frames).

TABLE I

| Threshold | 10% | | | 25% | | | 50% | | | 75% | | |
|---|---|---|---|---|---|---|---|---|---|---|---|---|
| Method | A | B | C | A | B | C | A | B | C | A | B | C |
| Histogram | 185 | 3274 | 33 | 30 | 12890 | 112 | 8 | 27897 | 253 | 2 | 45577 | 426 |
| Difference | | | | | | | | | | | | |
| (L1) | | | | | | | | | | | | |
| Histogram | 186 | 3254 | 32 | 31 | 12616 | 110 | 8 | 26529 | 237 | 2 | 45366 | 423 |
| Inter- | | | | | | | | | | | | |
| section | | | | | | | | | | | | |
| Histogram | 100 | 5023 | 41 | 15 | 22857 | 203 | 5 | 40676 | 382 | 1 | 58259 | 568 |
| Difference | | | | | | | | | | | | |
| (L2) | | | | | | | | | | | | |
| Chi Square | 568 | 669 | 1 | 91 | 51012 | 477 | 11 | 57746 | 558 | 1 | 58259 | 568 |
| Test | | | | | | | | | | | | |
| Bin-Wise | 568 | 669 | 1 | 568 | 669 | 1 | 178 | 6648 | 64 | 14 | 24671 | 219 |
| Histogram | | | | | | | | | | | | |
| Inter- | | | | | | | | | | | | |
| section | | | | | | | | | | | | |

Table I summarizes superhistogram families for various thresholds and histogram difference methods for one selected television program (i.e., one episode of the Seinfeld television program). In Table I, the letter “A” designates the number of families formed. The letter “B” designates the duration of the longest family in frames. The letter “C” designates the number of keyframes in the longest family.

As more fully described in the article “Color Super Histograms for Video Representation,” by modifying the threshold for the histogram distance measure the superhistogram method can produce a desired number of families (i.e., clusters) of keyframes. The number can be selectively varied in order to obtain a “compact” visual summary.

For example, assume that it is desired to obtain five (5) frames representing five (5) families from the superhistogram of the episode of the Seinfeld television program. Then a threshold of fifty percent (50%) and the L2 distance measure can be used. The number five (5) is located in column A under the fifty percent (50%) threshold for the L2 distance measure in Table I. For another example, assume that it is desired to obtain two (2) frames representing two (2) families from the superhistogram of the episode of the Seinfeld television program. Then a threshold of seventy five percent (75%) and the L1 distance measure can be used. The number two (2) is located in column A under the seventy five percent (75%) threshold for the L1 distance measure (or for the Histogram Intersection) in Table I.

Controller 130 executes keyframe selection application 250 to select representative keyframe images for each superhistogram. The selected representative keyframe images can be selected from either (1) the first image in the family histogram, or (2) the most meaningful image in the superhistogram, or (3) a randomly chosen image or an image that is closest to the cluster (family) center. The term “meaningful image” may refer to a frame with a person's face, an important text, etc. Visual summary application 260 then creates a compact visual summary using the selected keyframe images.

After visual summary application 260 has completed its operations, controller 130 stores the resulting compact visual summary in a visual summary storage location 270 in memory unit 120. Visual summary retrieval module 180 is capable of retrieving a compact visual summary that is stored in memory unit 120 and causing the retrieved compact visual summary to be displayed in the manner previously described.

In response to a user request, controller 130 is capable of accessing selected portions of video material summarized by the compact visual summary. The selected portions of video material are displayed by video processor 110. To access the video material controller 130 receives a user request that identifies and selects a keyframe image. Controller 130 then retrieves a compact visual summary from memory unit 120 that contains the selected keyframe image. Controller 130 uses the compact visual summary to access (i.e., identify the location of) the corresponding portion of the video material. Controller 130 then sends the location information of the video material to video processor 110. Video processor 110 then displays the selected portion of the video material.

In response to a user request, controller 130 is also capable of using a compact visual summary to assemble selected portions of summarized video material to form new video material. To create the new video material controller 130 receives a user request that identifies and selects keyframe images. Controller 130 then retrieves a compact visual summary from memory unit 120 that contains the selected keyframe images. Controller 130 uses the compact visual summary to access (i.e., identify the location of) the corresponding portions of the video material. Controller 130 then assembles the location information into a new arrangement as specified by the user. The location information arranges the selected portions of video material into new video material. Controller 130 then sends the location information of the individual selected portions of the new video material to video processor 110. Video processor 110 then displays the new video material.

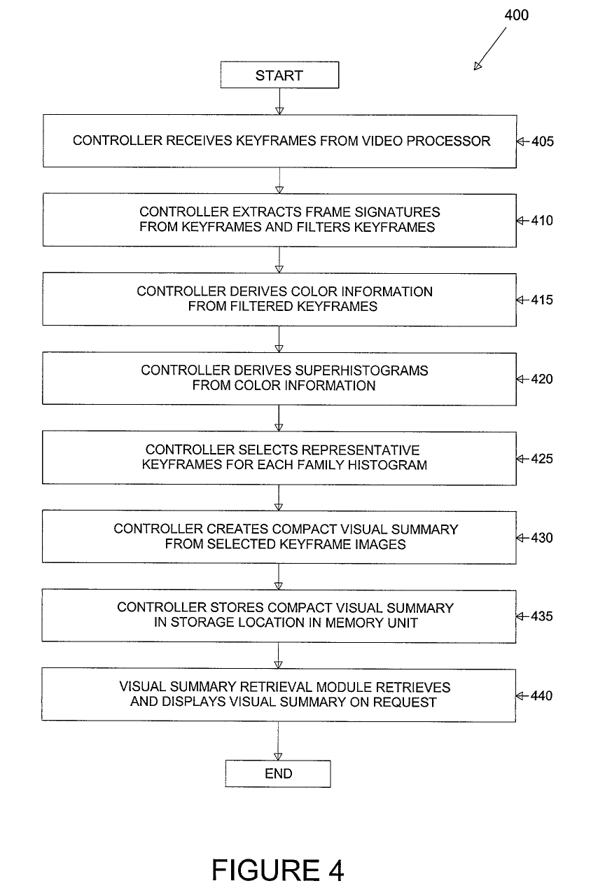

FIG. 4 illustrates a flow diagram showing an advantageous embodiment of the method of the present invention. The steps of the method are collectively referred to with the reference numeral 400. Controller 130 receives keyframes from video processor 110 (step 405). Controller 130 then extracts frame signatures from the keyframes and filters the keyframes (step 410). Controller 130 then derives color information from the filtered keyframes (step 415).

Controller 130 then derives superhistograms from the color information (step 420). Controller 130 then selects a representative keyframe or a representative set of multiple keyframes for each family histogram (step 425). Controller 130 then creates a compact visual summary from the selected keyframe images (step 430). Controller 130 then stores the compact visual summary in a visual summary storage location 270 within memory unit 120 (step 435). When requested by a user, visual summary retrieval module 180 retrieves a visual summary from memory unit 120 and causes it to be displayed (step 440).

While the present invention has been described in detail with respect to certain embodiments thereof, those skilled in the art should understand that they can make various changes, substitutions modifications, alterations, and adaptations in the present invention without departing from the concept and scope of the invention in its broadest form.

What is claimed is:

1. For use in a system capable of creating visual summaries of video material, an apparatus for creating a compact visual summary of video material, said apparatus comprising:
a visual summary controller capable of receiving keyframes of said video material;
wherein said visual summary controller is capable of extracting frame signatures from said keyframes, and capable of using said frame signatures to create superhistograms from said keyframes, and capable of using said frame signatures and said superhistograms to create a compact visual summary of said video material.

2. The apparatus as claimed in claim 1 wherein said visual summary controller is capable of filtering said keyframes and extracting frame signatures from said filtered keyframes before using said frame signatures to create said superhistograms to create a compact visual summary of said video material.

3. The apparatus as claimed in claim 2 wherein said visual summary controller is capable of creating said compact visual summary of said video material by using said superhistograms to cluster said filtered keyframes, and by adding a representative keyframe from said clustered keyframes to said compact visual summary of said video material.

4. The apparatus as claimed in claim 2 wherein said frame signature is a histogram.

5. The apparatus as claimed in claim 3 wherein the distance measure for clustering is equal to a histogram difference calculated by one of: L1 distance measure method, L2 distance measure method, histogram intersection method, Chi Square test method, and bin-wise histogram intersection method.

6. The apparatus as claimed in claim 3 wherein said visual summary controller is capable of selecting a representative image for each of said superhistograms, wherein said representative image is one of: the first image in each family histogram, the most meaningful image in each superhistogram, a randomly chosen image, and an image that is closest to the cluster center.

7. The apparatus as claimed in claim 5 wherein said visual summary controller is capable of selecting a family histogram to use to create said compact visual summary of said video material.

8. The apparatus as claimed in claim 1 wherein said visual summary controller further comprises:
a visual summary retrieval module capable of retrieving a compact visual summary stored in a memory unit and causing said compact visual summary to be displayed in response to a user request.

9. The apparatus as claimed in claim 3 wherein said visual summary controller is capable of using said compact visual summary to access at least one portion of said video material.

10. The apparatus as claimed in claim 3 wherein said visual summary controller is capable of using said compact visual summary to create new video material.

11. A system capable of creating visual summaries of video material, said system comprising an apparatus for creating a compact visual summary of video material, said apparatus comprising:
a visual summary controller capable of receiving keyframes of said video material;
wherein said visual summary controller is capable of extracting frame signatures from said keyframes, and capable of using said frame signatures to create superhistograms from said keyframes, and capable of using said frame signatures and said superhistograms to create a compact visual summary of said video material.

12. The system as claimed in claim 11 wherein said visual summary controller is capable of filtering said keyframes and extracting frame signatures from said filtered keyframes before using said frame signatures to create said superhistograms to create a compact visual summary of said video material.

13. The system as claimed in claim 12 wherein said visual summary controller is capable of creating said compact visual summary of said video material by using said superhistograms to cluster said filtered keyframes, and by adding a representative keyframe from said clustered keyframes to said compact visual summary of said video material.

14. The system as claimed in claim 12 wherein said frame signature is a histogram.

15. The system as claimed in claim 13 wherein the distance measure for clustering is equal to a histogram difference calculated by one of: L1 distance measure method, L2 distance measure method, histogram intersection method, Chi Square test method, and bin-wise histogram intersection method.

16. The system as claimed in claim 13 wherein said visual summary controller is capable of selecting a representative image for each of said superhistograms, wherein said representative image is one of: the first image in each family histogram, the most meaningful image in each superhistogram, a randomly chosen image, and an image that is closest to the cluster center.

17. The system as claimed in claim 16 wherein said visual summary controller is capable of selecting a family histogram to use to create said compact visual summary of said video material.

18. The system as claimed in claim 11 wherein said visual summary controller further comprises:
a visual summary retrieval module capable of retrieving a compact visual summary stored in a memory unit and causing said compact visual summary to be displayed in response to a user request.

19. The system as claimed in claim 13 wherein said visual summary controller is capable of using said compact visual summary to access at least one portion of said video material.

20. The system as claimed in claim 13 wherein said visual summary controller is capable of using said compact visual summary to create new video material.

21. For use in a system capable of creating visual summaries of video material, a method for creating a compact visual summary of video material, said method comprising the steps of:
receiving in a visual summary controller keyframes of said video material;
extracting frame signatures from said keyframes;
using said frame signatures to create superhistograms from said keyframes; and
using said frame signatures and said superhistograms to create a compact visual summary of said video material.

22. The method as claimed in claim 21 further comprising the steps of:
filtering said keyframes received in said visual summary controller; and
extracting frame signatures from said filtered keyframes before using said frame signatures to create said superhistograms to create a compact visual summary of said video material.

23. The method as claimed in claim 22 further comprising the steps of:
using said histograms to cluster said filtered keyframes; and
adding a representative keyframe from said clustered keyframes to said compact visual summary of said video material.

24. The method as claimed in claim 23 wherein the distance measure for clustering is equal to a histogram difference calculated by one of: L1 distance measure method, L2 distance measure method, histogram intersection method, Chi Square test method, and bin-wise histogram intersection method.

25. The method as claimed in claim 23 wherein said visual summary controller is capable of selecting a representative image for each of said superhistograms, wherein said representative image is one of: the first image in each family histogram, the most meaningful image in each superhistogram, a randomly chosen image, and an image that is closest to the cluster center.

26. The method as claimed in claim 23 further comprising the step of:
selecting a family histogram to use to create said compact visual summary of said video material.

27. The method as claimed in claim 23 further comprising the steps of:
retrieving a compact visual summary stored in a memory unit; and
causing said compact visual summary to be displayed in response to a user request.

28. The method as claimed in claim 23 further comprising the step of:
causing said visual summary controller to use said compact visual summary to access at least one portion of said video material.

29. The method as claimed in claim 23 further comprising the step of:
causing said visual summary controller to use said compact visual summary to create new video material.

30. For use in a system capable of creating visual summaries of video material, computer-executable instructions stored on a computer-readable storage medium for creating a compact visual summary of video material, the computer-executable instructions comprising the steps of:
receiving in a visual summary controller keyframes of said video material;
extracting frame signatures from said keyframes;
using said frame signatures to create superhistograms from said keyframes; and
using said frame signatures and said superhistograms to create a compact visual summary of said video material.

31. The computer-executable instructions stored on a computer-readable storage medium as claimed in claim 30 further comprising the step of:
filtering said keyframes received in said visual summary controller; and
extracting frame signatures from said filtered keyframes before using said frame signatures to create said superhistograms to create a compact visual summary of said video material.

32. The computer-executable instructions stored on a computer-readable storage medium as claimed in claim 31 further comprising the steps of:
using said histograms to cluster said filtered keyframes; and
adding a representative keyframe from said clustered keyframes to said compact visual summary of said video material.

33. The computer-executable instructions stored on a computer-readable storage medium as claimed in claim 32 wherein the distance measure for clustering is equal to a histogram difference calculated by one of: L1 distance measure method, L2 distance measure method, histogram intersection method, Chi Square test method, and bin-wise histogram intersection method.

34. The computer-executable instructions stored on a computer-readable storage medium as claimed in claim 32 wherein said visual summary controller is capable of selecting a representative image for each of said superhistograms, wherein said representative image is one of: the first image in each family histogram, the most meaningful image in each superhistogram, a randomly chosen image, and an image that is closest to the cluster center.

35. The computer-executable instructions stored on a computer-readable storage medium as claimed in claim 34 further comprising the step of:
selecting a family histogram to use to create said compact visual summary of said video material.

36. The computer-executable instructions stored on a computer-readable storage medium as claimed in claim 30 further comprising the steps of:
retrieving a compact visual summary stored in a memory unit; and
causing said compact visual summary to be displayed in response to a user request.

37. The computer-executable instructions stored on a computer-readable storage medium as claimed in claim 32 further comprising the step of:
causing said visual summary controller to use said compact visual summary to access at least one portion of said video material.

38. The computer-executable instructions stored on a computer-readable storage medium as claimed in claim 32 further comprising the step of:
causing said visual summary controller to use said compact visual summary to create new video material.
